(19) United States
(12) Patent Application Publication
(10) Pub. No.: US 2026/0108962 A1
(43) Pub. Date: Apr. 23, 2026

(54) ADJUSTABLE STAND

(71) Applicant: MILWAUKEE ELECTRIC TOOL CORPORATION, Brookfield, WI (US)

(72) Inventors: Garrett C. Waldron, Wauwatosa, WI (US); Kyle C. Loudon, Brown Deer, WI (US); Alex J. Brasel, Greenfield, WI (US); Cal T. McCarty, West Bend, WI (US)

(21) Appl. No.: 19/361,711

(22) Filed: Oct. 17, 2025

Related U.S. Application Data
(60) Provisional application No. 63/809,091, filed on May 20, 2025.
(60) Provisional application No. 63/708,813, filed on Oct. 18, 2024.

(51) Int. Cl. B23D 47/02; B25H 1/06

(52) U.S. Cl. CPC B23D 47/025; B25H 1/06

(57) ABSTRACT

A stand includes a base having a top surface on which a saw is supportable and from which a plurality of legs extend to support the base, an extension arm slidably adjustable relative to the base, and a clamp assembly configured to lock the extension arm. The extension arm includes a support to support a workpiece. The clamp assembly includes a collar with a stationary portion coupled to the base and a clamping portion movable relative thereto, each of the stationary and clamping portions having a clamp face engageable with the extension arm. The clamp assembly includes a rod extending between facing ends of the stationary and clamping portions, and a lever having a cam portion, the lever pivotably coupled to the rod and movable between a locked position to apply a clamping force to lock the extension arm and an unlocked position allowing sliding adjustment of the extension arm.

### CROSS-REFERENCE TO RELATED APPLICATIONS

This application claims priority to U.S. Provisional Patent Application No. 63/809,091, filed on May 20, 2025, and to U.S. Provisional Patent Application No. 63/708,813, filed on October 18, 2024, the entire content of each is incorporated herein by reference.

### FIELD

The present disclosure relates to miter saw stands, and more particularly to miter saw stands with extension arms and workpiece supports.

### BACKGROUND

A miter saw stand may contain one more extension arms that extend from the ends of the stand to support a workpiece. Each arm may include a vertical support to support a workpiece the same horizontal height as the height of the support surface of the miter saw to allow the user to make a straight cut through a workpiece. The length of the extension arms is adjustable relative to a base of the miter saw stand to support different workpiece lengths on the miter saw during a cutting operation.

### SUMMARY

The present disclosure provides, in one aspect, a stand configured to support a saw, the stand including: a base having a top surface on which the saw is supportable; a plurality of legs extending from and supporting the base; an extension arm that is slidably adjustable relative to the base, the extension arm including a support upon which a workpiece is supported; and a clamp assembly configured to lock the extension arm relative to the base, the clamp assembly including a collar having a stationary portion coupled to the base and a clamping portion that is movable relative to the stationary portion, the extension arm being slidable between the stationary portion and the clamping portion, and the stationary portion and the clamping portion each defining a clamp face engageable with the extension arm, a rod extending between facing ends of the stationary portion and the clamping portion, and a lever pivotably coupled to a first end of the rod and defining a cam portion, the lever movable between a locked position in which the respective clamp faces of the stationary portion and the clamping portion of the collar apply a clamping force to the extension arm to lock the extension arm relative to the base, and an unlocked position in which the extension arm is slidably adjustable relative to the base.

The present disclosure provides, in another aspect, a stand configured to support a saw, the stand including: a base having a top surface on which the saw is supportable; a plurality of legs extending from and supporting the base; an extension arm that is slidably adjustable relative to the base along a first axis, the extension arm including an arm portion extendible from the base along the first axis; a support upon which a workpiece is supported, the support coupled to the arm portion and slidably adjustable relative to the arm portion along a second axis, and a lock assembly to lock the support at a position along the second axis; and a clamp assembly configured to lock the extension arm relative to the base.

The present disclosure provides, in another aspect, a stand configured to support a saw, the stand including: a base having a top surface on which the saw is supportable; a plurality of legs extending from and supporting the base; an extension arm that is slidably adjustable relative to the base to the base along a first axis, the extension arm including an arm portion extendible from the base along the first axis; a support upon which a workpiece is supported, the support coupled to the arm portion and slidably adjustable relative to the arm portion along a second axis, and a lock assembly to lock the support at a position along the second axis; and a clamp assembly configured to lock the extension arm relative to the base, the clamp assembly including a collar having a stationary portion coupled to the base and a clamping portion that is movable relative to the stationary portion, the extension arm being slidable between the stationary portion and the clamping portion, and the stationary portion and the clamping portion each defining a clamp face engageable with the extension arm, a rod extending between facing ends of the stationary portion and the clamping portion, and a lever pivotably coupled to a first end of the rod and defining a cam portion, the lever movable between a locked position in which the respective clamp faces of the stationary portion and the clamping portion of the collar apply a clamping force to the extension arm to lock the extension arm relative to the base, and an unlocked position in which the extension arm is slidably adjustable relative to the base.

Other features and aspects of the subject matter will become apparent by consideration of the following detailed description and accompanying drawings.

### BRIEF DESCRIPTION OF THE DRAWINGS

FIG. 1 is a perspective view of a miter saw stand including a base upon which a miter saw is supported and extension arms protruding from opposite ends of the base.

FIG. 2 is a perspective view of the miter saw stand of FIG. 1.

FIG. 3 is a perspective view of an extension arm clamp for use in the miter saw stand of FIG. 1 to lock the extension arms relative to the base.

FIG. 4 is a top view of the extension arm clamp of FIG. 3.

FIG. 5 is a cross-sectional view of the extension arm clamp of FIG. 3 through section line 5-5 in FIG. 4.

FIG. 6 is a perspective view of an extension arm clamp for use in the miter saw stand of FIG. 1.

FIG. 7 is a perspective view of the extension arm clamp of FIG. 6.

FIG. 8 is a perspective view of a portion of an extension arm clamp for use in the miter saw stand of FIG. 1.

FIG. 9 is a side view of the extension arm clamp of FIG. 8.

FIG. 10 is a perspective view of a portion of the extension arm of FIG. 1.

FIG. 11 is a bottom view of a portion of the extension arm of FIG. 1.

Before any embodiments of the subject matter are explained in detail, it is to be understood that the subject matter is not limited in its application to the details of construction and the arrangement of components set forth in the following description or illustrated in the following drawings. The subject matter is capable of other embodiments and of being practiced or of being carried out in various ways. Also, it is to be understood that the phraseology and terminology used herein is for the purpose of description and should not be regarded as limiting.

### DETAILED DESCRIPTION

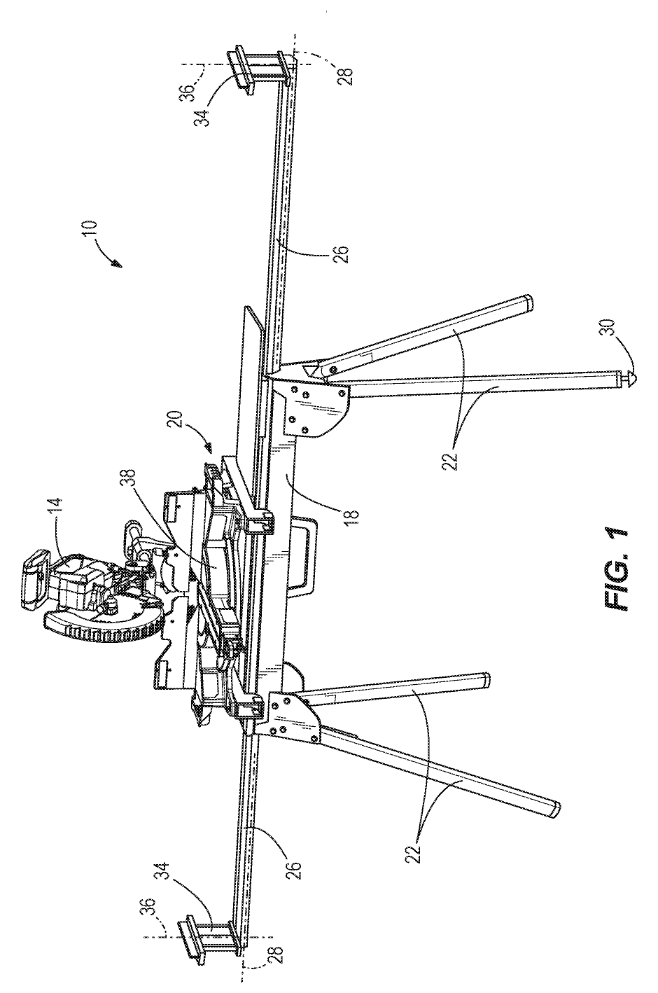

FIG. 1 illustrates an embodiment of an adjustable stand 10 configured to support a saw 14 (e.g., a miter saw). The stand 10 includes a base 18 having a top surface 20 on which the saw is supportable to which legs 22 (e.g., four legs) are pivotably coupled to support the stand 10 on a work surface and extension arms 26 that are extendable from the base 18 to support a workpiece. The legs 22 are movable along a first axis 28 between deployed positions (shown in FIG. 1) and folded positions for compact storage and transportation between jobsites. Each leg 22 may include a foot 30 that is adjustable to level the stand, and therefore the saw. The legs 22 may be lockable in the deployed and/or folded positions. The base 18, legs 22, and extension arms 26 may be steel, aluminum, high density plastic, or durable material that is suitably durable yet lightweight enough to transport. Each extension arm 26 includes a support 34 upon which a workpiece may be supported. The support 34 may be vertically adjustable along a second axis 36 to match the height of a saw table 38 in order to support the workpiece in a horizontally level position, allowing a user to cut the workpiece in a substantially vertical direction, or along a desired bevel angle, without the weight of the workpiece affecting the quality of the cut. In the illustrated embodiment, the first axis 28 and second axis 36 are transverse to one another. The workpiece support 34 may include a roller to facilitate positioning the workpiece relative to the blade of the saw 14 and/or a stop against which the end of the workpiece can be abutted to provide for repetitive and reproducible cutting of multiple workpieces.

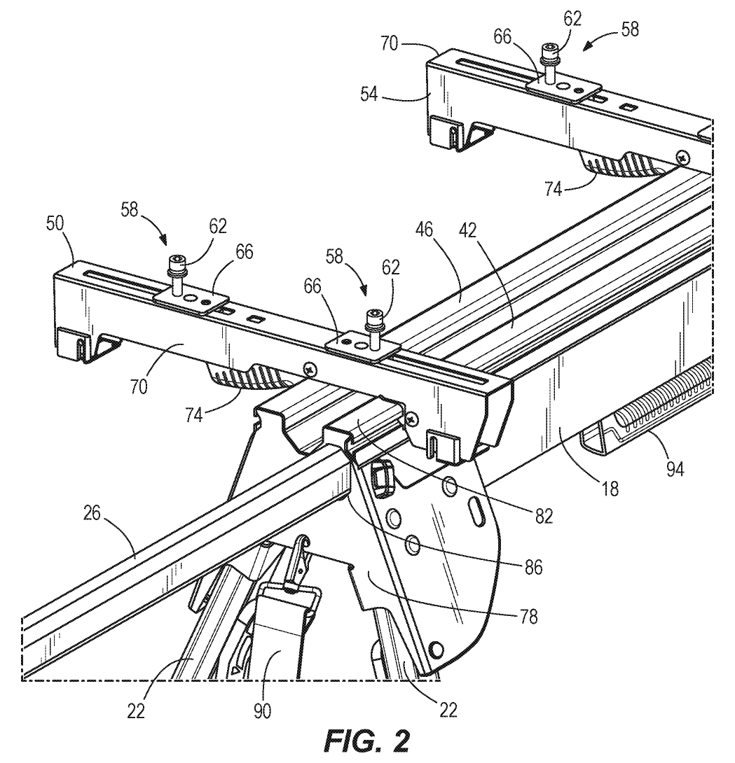

With reference to FIG. 2, the base 18 includes first and second parallel ridges 42, 46 that are engageable by first and second saw support extensions 50, 54 that can be laterally positioned relative to each other to accommodate different saw sizes and laterally positioned relative to the base 18 to support the saw 14 anywhere along the length of the base 18. Each of the first and second support extensions 50, 54 includes mounting provisions 58 (e.g., a bolt 62 engageable with a nut, not shown, positioned in the support extensions 50, 54 and a mounting plate 66, the bolt 62, nut, and mounting plate 66 positionable along the body 70 of the support extensions 50, 54). When each support extension 50, 54 is positioned in the desired location, a clamp 74 locks the support extension 50, 54 in place.

First and second side plates 78 are coupled to the ends 82 of the base 18 and include holes 86 through which the extension arms 26 extend for sliding adjustment. While only one side of the stand 10 is shown, the other side is to be understood as substantially similar to the first side described. The holes 86 have an octagonal shape corresponding to the cross-section of the extension arms 26. In other embodiments, the arms and holes may have a different cross-sectional shape. In the present embodiment, the extension arm 26 extending from the left-side plate 78 is partially telescopically nested within the ridge 42 closer to the user (e.g., the right ridge of FIG. 2) and the extension arm 26 extending from the right-side plate is telescopically nested within the ridge 46 further from the user (e.g., the left ridge of FIG. 2). In other embodiments, the arms may be telescopically nested in the opposite ridge. In still other embodiments, each arm may include a front portion and a rear portion, with the front portion telescopically nested in the ridge closer to the user and the rear portion telescopically nested in the ridge further from the user. The stand 10 may include one or more carrying provisions, such as a shoulder strap 90 (e.g., a nylon shoulder strap with metal end clips) coupled to the side plates 78, a handle 94 coupled to the base 18, or another structure that can be gripped or otherwise carried by a user.

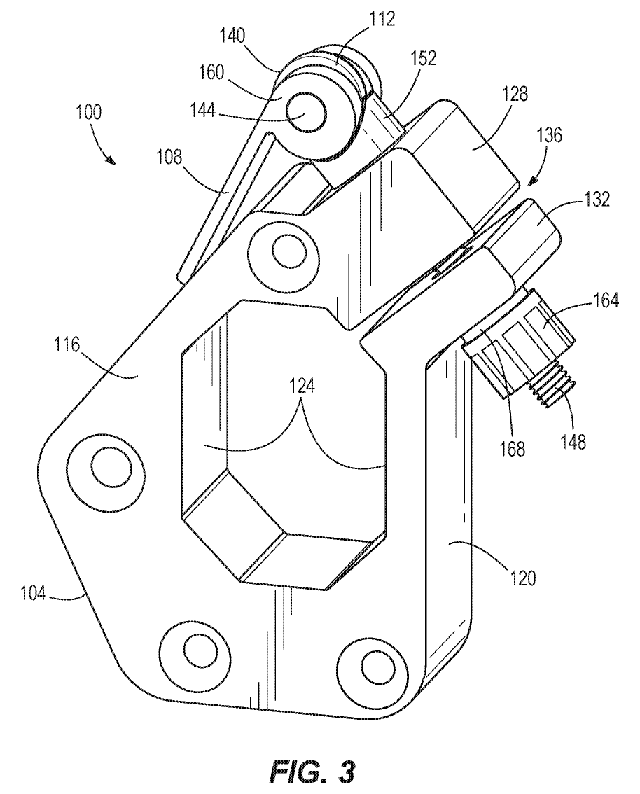

The stand 10 includes one or more clamp assemblies 100, illustrated in FIG. 3, corresponding to each extension arm 26 to selectively position the extension arm 26 and prevent the position of the extension arm 26 changing as the workpiece is positioned for a cut and a cutting operation is performed. The clamp assemblies 100 are coupled to the side plates 78.

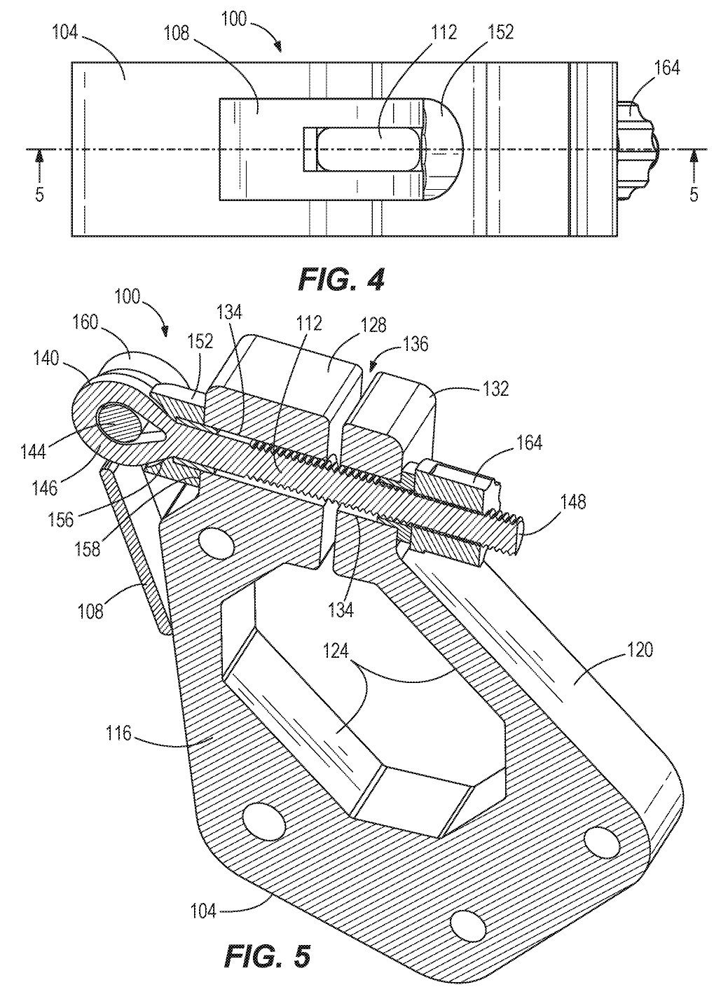

With reference to FIGS. 3-5, the clamp assembly 100 includes a collar 104, a lever 108, and a rod 112. The lever 108 is movable between locked and unlocked positions (locked position shown) to clamp and release the extension arm 26. The collar 104 has a stationary portion 116 that is coupled to the base 18 (e.g., to the side plate 78 using fasteners) and a clamping portion 120 that is movable relative to the stationary portion 116. The stationary portion 116 and clamping portion 120 each define a clamp face 124 that is engageable with the extension arm 26. The stationary portion 116 and clamping portion 120 define facing ends 128, 132, with a gap 136 having a variable width positioned between the ends 128, 132.

The rod 112 extends between the ends 128, 132 (e.g., through holes 134) of the stationary portion 116 and the clamping portion 120. A first end 140 of the rod 112 is positioned on one side of one of the ends (e.g., the end 128 of the stationary portion 116) and is coupled to the lever 108 by a pin 144 (e.g., a pin 144 that is press-fit in the lever 108 and extends through an eye portion 146 of the rod 112). In other embodiments, the lever 108 may be coupled to the rod 112 by another structure. The second end 148 of the rod 112 is positioned on an opposite side of the other end (e.g., the end 132 of the clamping portion 120). The rod 112 in the present embodiment is a threaded rod. A spacer 152 including a cam face 156 (FIG. 5) and a clamp face 158 is positioned on the rod 112 between an eccentric cam portion 160 of the lever 108 and the end 128 of the stationary portion 116. The cam face 156 is engageable with the cam portion 160, and the clamp face 158 is engageable with the end 128 of the collar 104. A lock nut 164 is coupled (e.g., by threading) to the second end 148 of the rod 112 and is adjustable along the length of the rod 112 to engage the end 132 of the collar 104. A second spacer 168 may be positioned on the rod 112 between the lock nut 164 and the end 132 of the clamping portion 120.

When the lever 108 is in the unlocked position, the extension arm 26 is slidable between the stationary portion 116 and the clamping portion 120. When the lever 108 is the locked position, the clamp faces 124 engage the extension arm 26 and apply a clamping force to the extension arm 26. Rotation of the lever 108 results in engagement of the cam portion 160 with the cam face 156 and the eccentric mounting of the cam portion 160 translates the rod 112, drawing the lock nut 164 and spacer toward and into engagement with the end 132. As the lever 108 continues to rotate, a tensile force is applied through the rod 112 and the lock nut 164, resulting in bending deformation of the collar 104 as the end 132 of the clamping portion 120 is drawn toward the end 128 of the stationary portion 116, reducing the width of the gap 136.

Bending deformation of the clamping portion 120 relative to the stationary portion 116 applies a clamping force to the extension arm 26 and prevents sliding of the extension arm 26 relative to the base 18 (i.e., due to the resulting friction force between the clamp assembly 100 and the extension arm 26, which is a function of the clamping force applied). The clamping force is adjustable by threading the lock nut 164 along the rod 112. Turning the lock nut 164 (e.g., in a clockwise direction) to translate the lock nut 164 along the rod 112 toward the collar 104 reduces the gap 136 between the ends 128, 132, thereby preloading the clamping portion 120 such that it can apply a greater clamping force to the extension arm 26 when the lever 108 is pivoted to the locked position. Oppositely threading the lock nut 164 away from the collar 104 reduces the clamping force applied to the extension arm 26.

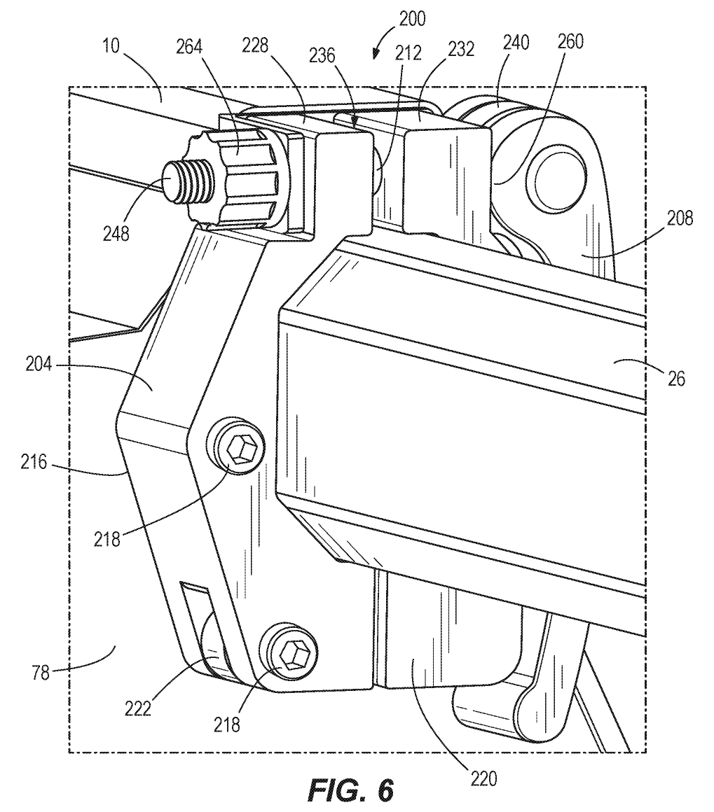

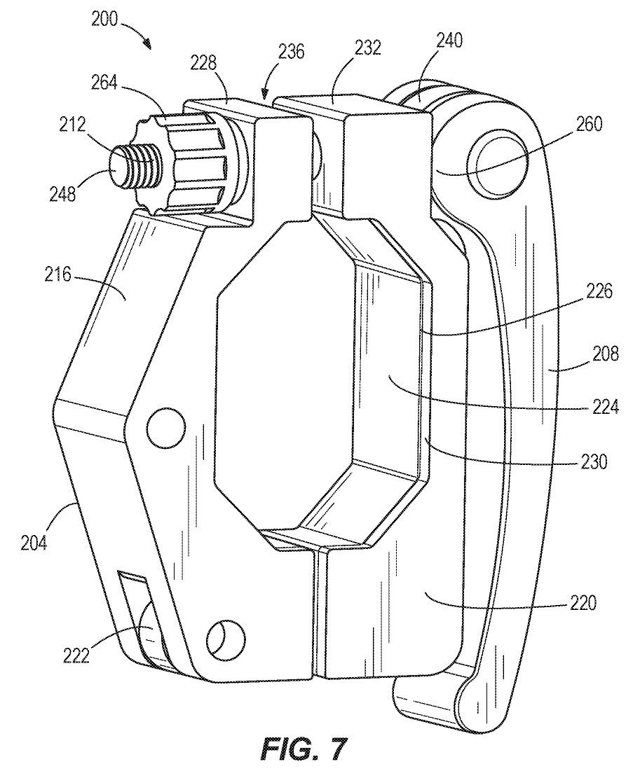

FIGS. 6 and 7 illustrate another embodiment of a clamp assembly 200, with like components and features as the embodiment of the clamp assembly 100 shown in FIGS. 3-5 being labeled with like reference numerals plus “100.” The clamp assembly 200 is couplable to a side plate 78 of the stand 10. The clamp assembly 200 includes a collar 204, lever 208, and rod 212. The lever 208 is pivotable between locked and unlocked positions to clamp and release the extension arm 26. A stationary portion 216 of the collar 204 is coupled to the side plate 78 (e.g., with fasteners 218) while a clamping portion 220 of the collar 204 is movable relative to the stationary portion 216. In the embodiment illustrated in FIGS. 6 and 7, the stationary portion 216 and clamping portion 220 are formed as separate components coupled by a hinge 222. Prior to assembly of the clamp assembly 200 to the stand 10, the hinge 222 permits rotation of the clamping portion 220 relative to the stationary portion 216 to facilitate assembly of the clamp assembly 200. Once coupled to the stand 10 by fasteners 218, rotation about the hinge 222 is prevented by the clamping force applied by the fasteners 218. That is, when the collar 204 is coupled to the stand 10, the stationary portion 216 and clamping portion 220 deform in a similar manner as collar 104 described above. An insert 226 (e.g., a plastic insert) is coupled to one or more interior faces 230 of each of the stationary portion 216 and the clamping portion 220. The inserts 226 include clamping faces 224 that engage the extension arm 26. The inserts 226 may be coupled by an adhesive or other fastening method.

Clamp assembly 200 functions substantially the same as clamp assembly 100. The rod 212 extends through and couples ends 228, 232 of the stationary portion 216 and clamping portion 220. The lever 208 is coupled to a first end 240 of the rod 212 and a lock nut 264 is coupled (i.e., threaded on) the opposite second end 248 of the rod 212 on opposite sides of the ends 228, 232 of the collar 204. The lock nut 264 is adjustable along the rod 212. The lever includes an eccentric cam portion 260 facing, and engageable with, the end 232 of the clamping portion 220. In other embodiments, a spacer maybe positioned between the cam portion 260 and the clamping portion 220. In some embodiments, a second spacer may be positioned on the rod 212 between the lock nut 264 and the end 232 of the clamping portion 220.

When the lever 208 is in the unlocked position, the extension arm 26 is slidable between the stationary portion 216 and the clamping portion 220. When the lever 208 is the locked position, the clamping faces 224 of the inserts 226 engage the extension arm 26 and apply a clamping force to the extension arm 26. Rotation of the lever 208 results in engagement of the cam portion 260 with the end 232 of the clamping portion 220 and the eccentric mounting of the cam portion 260 translates the rod 212, drawing the lock nut 264 toward and into engagement with the end 228. As the lever 208 continues to rotate, a tensile force is applied through the rod 212 and the lock nut 264, resulting in bending deformation of the collar 204 as the end 232 of the clamping portion 220 is drawn toward the end 228 of the stationary portion 216.

Bending deformation of the clamping portion 220 relative to the stationary portion 216 applies a clamping force to the extension arm 26 and prevents sliding of the extension arm 26 relative to the base 18 (i.e., due to the resulting friction force between the clamp assembly 100 and the extension arm 26, which is a function of the clamping force applied). The clamping force is adjustable by threading the lock nut 264 along the rod 212. Turning the lock nut 264 (e.g., in a clockwise direction) to translate the lock nut 264 along the rod 212 toward the collar 204 reduces the gap 236 between the ends 228, 232, thereby preloading the clamping portion 220 such that it can apply a greater clamping force to the extension arm 26 when the lever 208 is pivoted to the locked position. Oppositely threading the lock nut 264 away from the collar 204 reduces the clamping force applied to the extension arm 26.

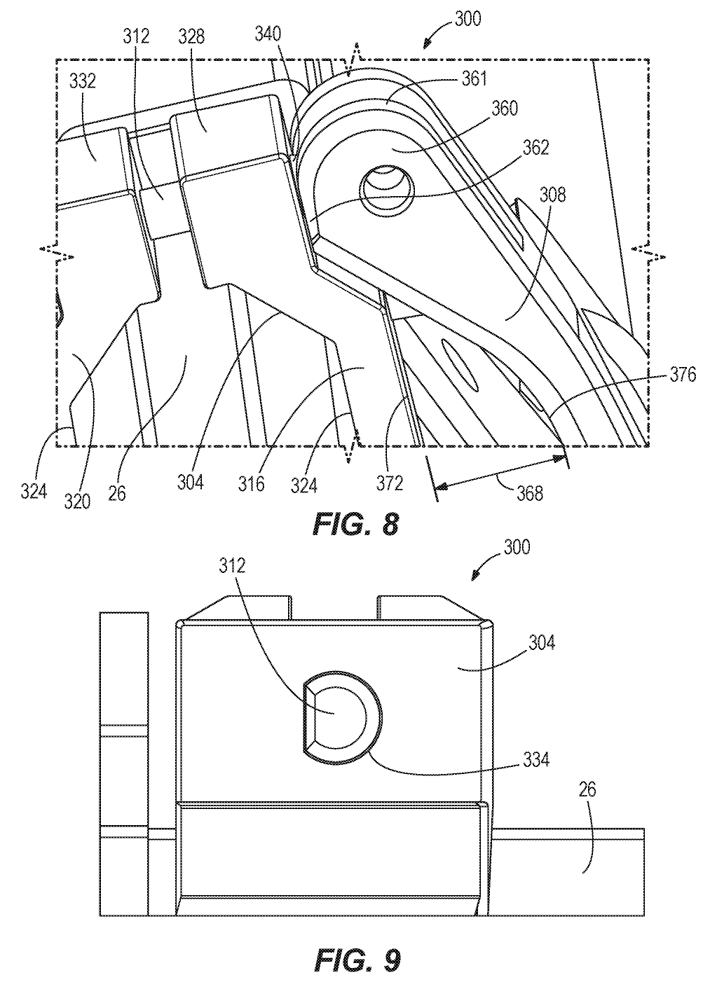

FIGS. 8 and 9 illustrate another embodiment of a clamp assembly 300, with like components and features as the embodiment of the clamp assembly 100 shown in FIGS. 3-5 being labeled with like reference numerals plus “200.” It should be understood that the clamp assembly 300 is substantially similar to the previously described embodiments of clamp assemblies 100, 200 and only differences between the third embodiment of the clamp assembly 300 and the previously described clamp assemblies 100, 200 will be discussed.

The clamp assembly 300 includes a collar 304, a lever 308 that is movable between locked and unlocked positions to clamp and release the extension arm 26, and a rod 312. The collar 304 includes a stationary portion 316 coupled to the base 18 and a clamping portion 320 that may be either integrally formed similar to collar 104 or coupled by a hinge similar to collar 204. The ends 328, 332 of the stationary and clamping portions 316, 320 each include a hole 334 through which the rod 312 extends to couple ends 328, 332. In the embodiment of FIGS. 8 and 9, each hole 334 has a D-shaped cross-section. The rod 312 has a corresponding D-shaped cross-section. The flat portions of the cross-sections of the holes 334 and the rod 312 cooperate to prevent rotation of the rod 312 relative to the collar 304.

The lever 308 is coupled to a first end 340 of the rod 312 and a lock nut (not shown) is coupled (i.e., threaded) to the opposite end of the rod 312 on opposite sides of the ends 328, 332 of the collar 304. As shown in FIG. 8, the lever 308 includes a cam portion 360. The cam portion 360 is eccentric, similar to previously described cam portions 160, 260 of levers 108, 208. The cam portion 360 of the embodiment in FIG. 8 includes a curved portion 361 and flat surface 362 that engages the collar 304 when the lever 308 is positioned in the locked position shown in FIG. 8. The lever 308 is illustrated as engaging the stationary portion 316, but it should be understood that the clamp assembly 300 could be arranged such that the lever 308 engages the clamping portion 320, which is also applicable to the previously described embodiments of clamp assemblies 100, 200. A lever distance 368 is defined between the outer face 372 of the collar 304 (e.g., the stationary portion 316 facing the lever 308) and the inner furthest point of the inner face 376 of the lever 308 from the collar 304. It will be appreciated that the lever distance 368 is large enough for a user to grasp the lever 308, for instance, by at least partially inserting a portion of one or more fingertips between the lever 308 and the collar 304. In previous embodiments, the lever 108, 208 was positioned in a closer relationship with the collar for a smaller profile relative to lever 308.

The clamp assembly 300 functions substantially the same as clamp assemblies 100, 200. When the lever 308 is in the unlocked position, the extension arm 26 is slidable between the stationary portion 316 and the clamping portion 320. When the lever 308 is the locked position, the clamping faces 324 engage the extension arm 26 and apply a clamping force to the extension arm 26. Rotation of the lever 308 results in engagement of the cam portion 360 with the end 328 of the clamping portion 316 and the eccentric mounting of the cam portion 360 translates the rod 312, drawing the lock nut (not shown) toward and into engagement with the end 328. As the lever 308 continues to rotate, a tensile force is applied through the rod 312 and the lock nut (not shown), resulting in bending deformation of the collar 304 (or pivoting rotation) as the end 332 of the clamping portion 320 is drawn toward the end 328 of the stationary portion 316. The flat surface 362 of the cam portion 360 engages the collar 304 when the lever 308 is positioned in the locked position. It will be appreciated that engagement of the flat surface 362 of the cam portion maintains the lever 308 in the locked position as well as provides a tactile indication to a user that the lever 308 has reached the locked position.

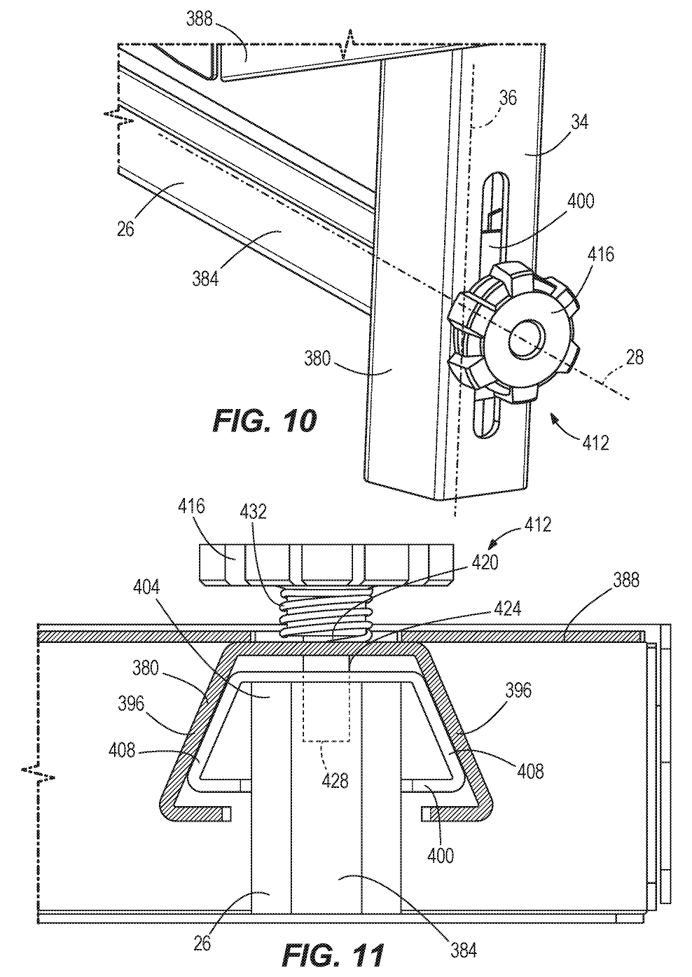

With reference to FIGS. 10 and 11, an embodiment of the support 34 of the extension arm 26 is shown. The support 34 includes a first support portion 380 coupled to the arm portion 384 of the extension arm 26 and is slidable relative to the arm portion 384 along the second axis 36. The support 34 also includes a second support portion 388 coupled to the first support portion 380. The first support portion 380 and second support portion 388 are slidable with the arm portion 384 relative to the base 18 along the first axis 28. The first and second support portions 380, 388 are arranged in a T-shaped arrangement with the second support portion 388 providing a horizontal surface on which a workpiece can be supported. The first support portion 380 is configured as a hollow channel having a trapezoidal cross-section. The trapezoidal cross-section has converging sides 396. The converging sides 396 converge (i.e., are closer to one another) in a direction along the first axis 28 away from the base 18. The second support portion 388 may include positioning structures to position or provide a stop for a workpiece, e.g., to position the workpiece at a desired cutting length, or clamping structures to clamp the workpiece in position and prevent the workpiece from moving relative to the saw while a cutting operation is completed.

A support seat 400 is coupled to the distal end 404 of the arm portion 384 and is received inside of the first support portion 380. The support seat 400 has a trapezoidal cross-section that is received within the channel of the first support portion 380. The first support portion 380 is slidable relative to the support seat 400 along the second axis 36. The trapezoidal cross-section of the support seat 400 corresponds to the trapezoidal cross-section of the first support portion 380. In that regard, the trapezoidal cross-section of the support seat 400 has converging sides 408 that engage the converging sides 396 of the first support portion 380 and converge at the same angle and in the same direction.

The support 34 also includes a lock assembly 412. The lock assembly 412 includes a knob 416 coupled to a first end 420 of a threaded shaft 424. The opposite second end 428 of the threaded shaft 424 is threadedly coupled to the arm portion 384 (e.g., to a threaded insert within the arm portion 384). The knob 416 and threaded shaft 424 are rotatable between a locking position and a release position. In the locked position, a larger portion of the threaded shaft 424 is threaded into the arm portion than in the release position. When the knob 416 is rotated to the locking position, the converging sides 408 of the support seat 400 are frictionally engaged with the converging sides of the first support portion 380. A biasing member 432 (e.g., a compression spring) is positioned on the threaded shaft 424 between the knob 416 and the first support portion 380. The biasing member 432 is in a compressed state such that it applies a biasing force to the knob 416 and the first support portion 380. The reaction of the biasing force against the knob 416 pushes the knob 416 away from the first support portion 380 and likewise pushes the first support portion 380 in an opposite direction while pulling the support sear 400 toward the support portion 380. The biasing member 432 therefore pushes the converging sides 396 of the first support portion 380 into engagement with the converging sides 408 of the support seat 400. The biasing force creates a friction force between the support seat 400 and the first support portion 380. When the knob 416 is rotated to the release position, the biasing member 432 biases the converging sides 408 of the support seat 400 to engage the converging sides 396 of the first support portion 380. It will be appreciated that the resulting friction force between the first support portion 380 and the support seat 400 inhibits or prevents the support 34 from sliding relative to the arm portion 384, allowing a user to adjust the vertical position of the support 34 without the need to maintain constant contact with and support of the support 34 to hold the support 34 in place. In other embodiments, the knob may be replaced by a lever having an eccentric cam, with rotation of the lever locking the position of the support 34 relative to the extension arm 26.

Although the subject matter has been described in detail with reference to certain preferred embodiments, variations and modifications exist within the scope and spirit of one or more independent aspects of the subject matter as described.

Various features of the subject matter are set forth in the following claims.

What is claimed is:

1. A stand configured to support a saw, the stand comprising:
a base having a top surface on which the saw is supportable;
a plurality of legs extending from and supporting the base;
an extension arm that is slidably adjustable relative to the base, the extension arm including a support upon which a workpiece is supported; and
a clamp assembly configured to lock the extension arm relative to the base, the clamp assembly including
a collar having a stationary portion coupled to the base and a clamping portion that is movable relative to the stationary portion, the extension arm being slidable between the stationary portion and the clamping portion, and the stationary portion and the clamping portion each defining a clamp face engageable with the extension arm,
a rod extending between facing ends of the stationary portion and the clamping portion, and
a lever pivotably coupled to a first end of the rod and defining a cam portion, the lever movable between a locked position in which the respective clamp faces of the stationary portion and the clamping portion of the collar apply a clamping force to the extension arm to lock the extension arm relative to the base, and an unlocked position in which the extension arm is slidably adjustable relative to the base.

2. The stand of claim 1, wherein the clamp assembly further comprises:
a lock nut coupled to a second end of the rod and engageable with the collar; and
a spacer positioned on the rod between the cam portion and the collar, the spacer including a cam face engageable with the cam portion and a clamp face engageable with the collar.

3. The stand of claim 2, wherein the lock nut is threaded to the rod and rotatable along the rod.

4. The stand of claim 1, wherein the base includes a side plate to which the stationary portion of the collar is coupled.

5. The stand of claim 1, wherein the extension arm is a first extension arm extending from a first end of the base, wherein the stand further comprises a second extension arm extending from an opposite, second end of the base, wherein the clamp assembly is a first clamp assembly for locking the first extension arm to the base, and wherein the stand further comprises a second clamp assembly for locking the second extension arm to the base.

6. The stand of claim 1, wherein the rod has an eye portion pivotably coupled to the lever by a pin.

7. The stand of claim 1, wherein the facing ends each define a hole through which the rod extends.

8. The stand of claim 7, wherein each hole has a D-shaped cross-section and the rod has a corresponding D-shaped cross-section.

9. The stand of claim 1, wherein the clamping portion is coupled to the stationary portion by a hinge.

10. The stand of claim 1, wherein the cam portion defines a flat surface that engages the collar when the lever is positioned in the locked position.

11. A stand configured to support a saw, the stand comprising:
a base having a top surface on which the saw is supportable;
a plurality of legs extending from and supporting the base;
an extension arm that is slidably adjustable relative to the base along a first axis, the extension arm including
an arm portion extendible from the base along the first axis;
a support upon which a workpiece is supported, the support coupled to the arm portion and slidably adjustable relative to the arm portion along a second axis, and
a lock assembly to lock the support at a position along the second axis; and
a clamp assembly configured to lock the extension arm relative to the base.

12. The stand of claim 11, wherein the lock assembly includes a knob threadedly coupled to the arm portion.

13. The stand of claim 12, wherein the support includes a first support portion coupled to the arm portion and a second support portion coupled to the first support portion on which the workpiece is supported.

14. The stand of claim 13, wherein the lock assembly further includes a biasing member engaging the knob and the first support portion.

15. The stand of claim 14, wherein the biasing member is a compression spring.

16. The stand of claim 11, wherein the first axis is transverse to the second axis.

17. The stand of claim 14, wherein the arm portion includes a support seat positioned at a distal end of the arm portion, and the first support portion defines a channel in which the support seat is received.

18. The stand of claim 17, wherein the support seat has a first trapezoidal cross-section defining converging sides, the first support portion having a second trapezoidal cross-section defining converging sides, and wherein the converging sides of the support seat are frictionally engaged with the converging sides of the first support portion when the knob is rotated to a locking position.

19. The stand of claim 18, wherein the biasing member biases the converging sides of the support seat to engage the converging sides of the first support portion to create friction therebetween when the knob is rotated to a release position.

20. A stand configured to support a saw, the stand comprising:
a base having a top surface on which the saw is supportable;
a plurality of legs extending from and supporting the base;
an extension arm that is slidably adjustable relative to the base to the base along a first axis, the extension arm including
an arm portion extendible from the base along the first axis;
a support upon which a workpiece is supported, the support coupled to the arm portion and slidably adjustable relative to the arm portion along a second axis, and
a lock assembly to lock the support at a position along the second axis; and
a clamp assembly configured to lock the extension arm relative to the base, the clamp assembly including
a collar having a stationary portion coupled to the base and a clamping portion that is movable relative to the stationary portion, the extension arm being slidable between the stationary portion and the clamping portion, and the stationary portion and the clamping portion each defining a clamp face engageable with the extension arm,
a rod extending between facing ends of the stationary portion and the clamping portion, and
a lever pivotably coupled to a first end of the rod and defining a cam portion, the lever movable between a locked position in which the respective clamp faces of the stationary portion and the clamping portion of the collar apply a clamping force to the extension arm to lock the extension arm relative to the base, and an unlocked position in which the extension arm is slidably adjustable relative to the base.
